(19) United States
(12) Patent Application Publication
(10) Pub. No.: US 2005/0202129 A1
(43) Pub. Date: Sep. 15, 2005

(54) Simulated silver foil chocolate or candy bar wrapper

(76) Inventor: Joseph S. Sieber, Weston, MA (US)

Correspondence Address: WOLF GREENFIELD & SACKS, PC;FEDERAL RESERVE PLAZA, 600 ATLANTIC AVENUE, BOSTON, MA, 02210-2211, US

(21) Appl. No.: 11/078,649

(22) Filed: Mar. 11, 2005

Related U.S. Application Data
(60) Provisional application No. 60/552,540, filed on Mar. 12, 2004.

(51) Int. Cl. A23B 4/00

(52) U.S. Cl. 426/112

(57) ABSTRACT

A candy bar wrapper including a first portion constructed and arranged to, when folded, surround a candy bar, wherein at least one edge of the first portion includes a strip of silver material.

### CROSS REFERENCE TO RELATED APPLICATIONS

This application claims priority under 35 U.S.C. §119(e) to U.S. Provisional Application Ser. No. 60/552,540, entitled “SIMULATED SILVER FOIL CHOCOLATE OR CANDY BAR WRAPPER,” filed on Mar. 12, 2004, which is herein incorporated by reference in its entirety.

### BACKGROUND OF THE INVENTION

For years chocolate bars products by Hershey and Nestle, among others, have been wrapped in a thin silver foil wrap and then over-wrapped with a printed paper label that was wrapped around the bar and glued together. The paper wrapper was shorter than the candy bar and silver wrap thereby leaving ⅛″-¼″ of exposed silver foil. A market for personalized and relabeled chocolate bars that have been used as gifts, greetings, party favors, or announcements has developed. In this case the original candy bar is relabeled with a new outer label that might say “It's a Boy—John Jones Dec. 31, 2004”.

In some cases the original silver foil and paper label are left on and over-wrapped with the personalized wrapper. This allows the buyer to remove the “greeted” wrapper and still be able to see underneath the actual wrapper with nutritional information etc. In other uses the original paper wrapper is removed and the new “greeted” wrapper is wrapped around the foil wrapper. In both cases the greeted wrapper is attached to the chocolate bar so that the silver foil shows. This exposed silver foil has become the essential visual identifier of a traditional chocolate bar and therefore an important feature of “greeted” chocolate bars.

Recently, the silver-foil-wrapped chocolate bar was discontinued by Hershey and Nestle. A single piece wrapper that is sealed on each end has replaced it. This wrapper no longer has the exposed silver foil on the ends. The greeted wrapper can still be wrapped around the chocolate bar, but the exposed wrapper is unappealing to consumers. The use of “greeted” wrappers has become a problem as a result, since it has lost its “trademark” identification created by the exposed silver foil on the ends.

### SUMMARY OF THE INVENTION

The present invention is directed to a candy bar wrapper, comprising a first portion constructed and arranged to, when folded, surround a candy bar, wherein at least one edge of the first portion includes a strip of silver material.

According to an embodiment of the invention, the two edges of the first portion include a strip of silver material.

According to an embodiment of the invention, the two edges are opposite each other.

According to an embodiment of the invention, the candy bar wrapper further comprises a tab attached to each edge.

According to an embodiment of the invention, the tab is silver.

### BRIEF DESCRIPTION OF THE DRAWINGS

FIG. 1 illustrates a traditional foil wrapped candy bar with the branded wrapper removed.

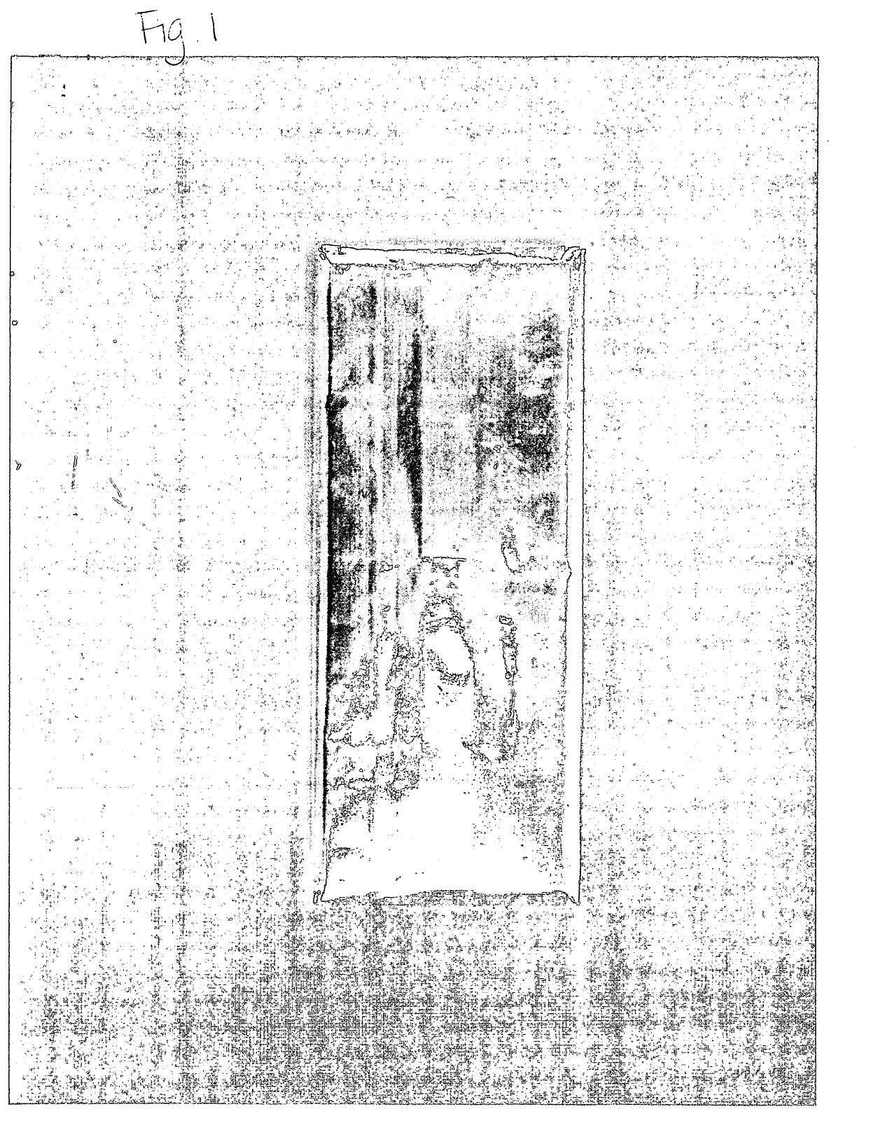

FIG. 2 illustrates a traditional foil wrapped candy bar with a personalizable label.

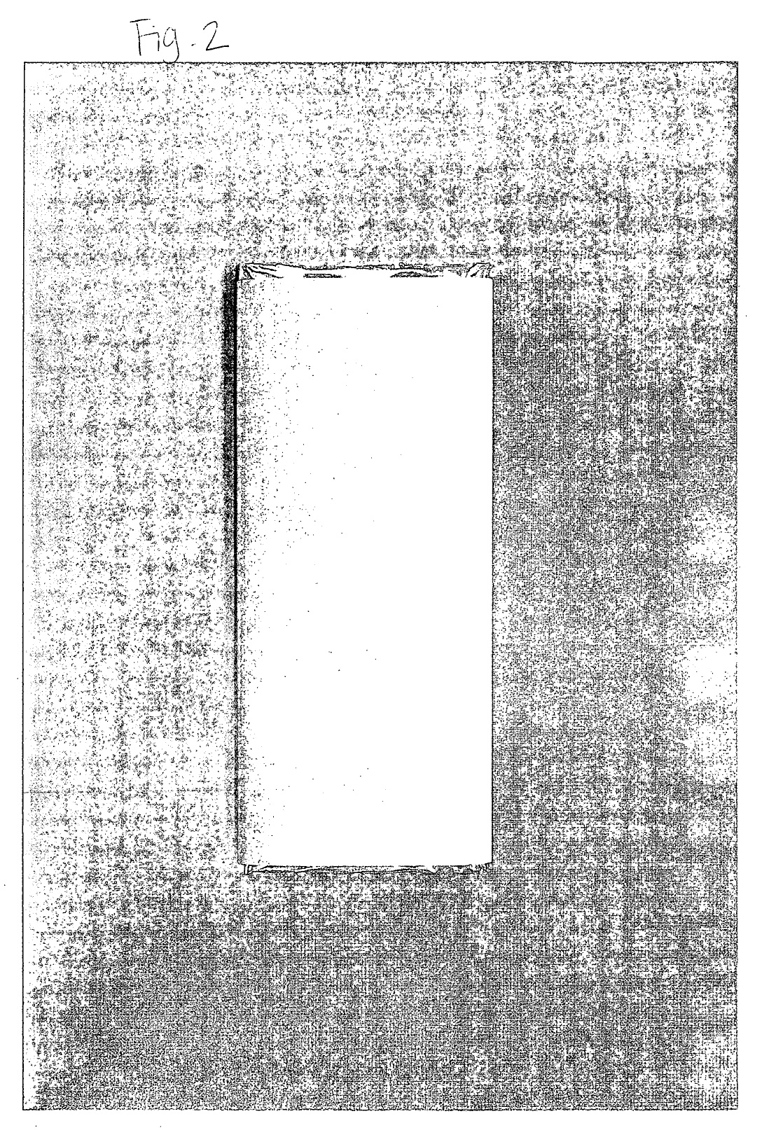

FIG. 3 illustrates a current candy bar with personalizable label.

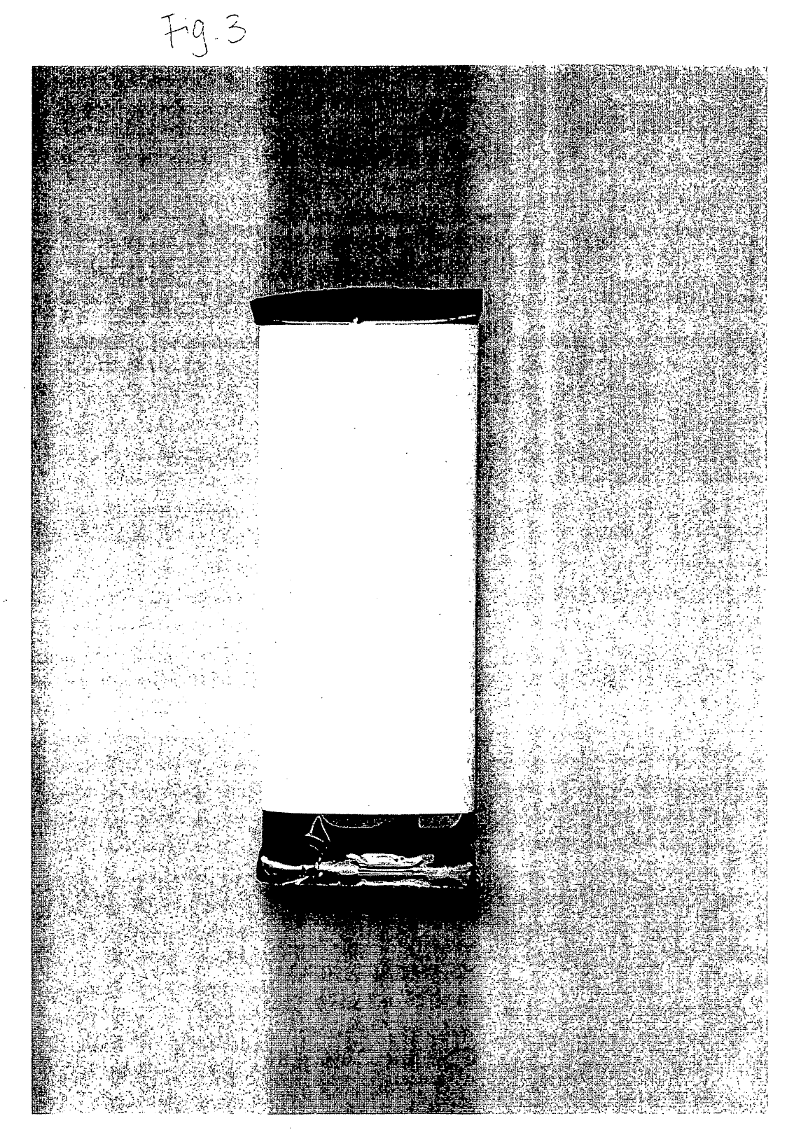

FIG. 4 illustrates a current candy bar.

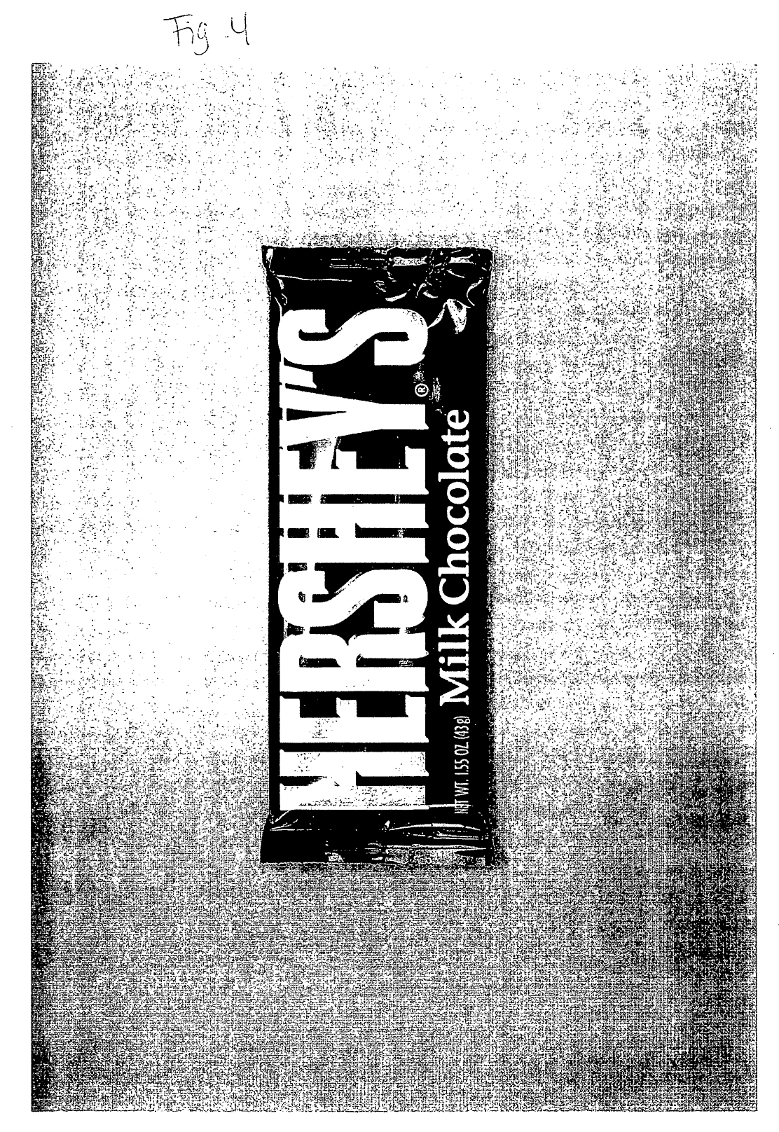

FIG. 5 illustrates a candy bar wrapper according to the invention.

FIG. 6 illustrates a candy bar wrapper according to the invention wrapped around a current style candy bar.

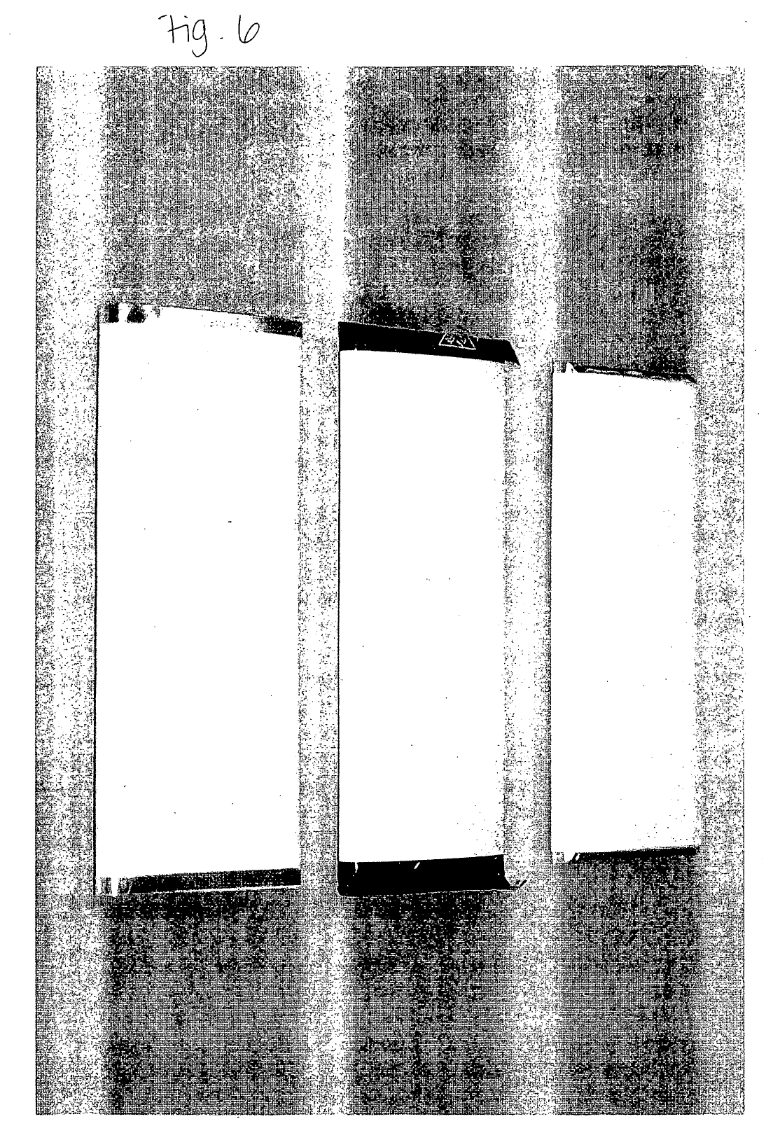

### DESCRIPTION OF THE INVENTION

One object of the invention is to restore the look of the original wrapper to the personalized chocolate package. One solution is to rewrap or over wrap the bars by machine. This requires them to be done at a central location, which then has the problem of how to ship a product that is sensitive to the heat (it melts) to a retailer during hot weather (all year in the south, in summer in the north). Hershey has such a distribution infrastructure, but it can't be created for the personalized market.

Another alternative is an approach in which a local store or consumer can purchase the new bars (which are available locally) and modify them to get the desired look. One greeted wrapper company has suggested in their marketing material that users should rewrap the chocolate bar with silver foil. You could remove the entire one piece wrapper and wrap with silver foil and the greeted wrapper or over-wrap the entire one piece wrapper with silver foil and then wrap it with a greeted wrapper. The first of these solutions is a sanitary problem and the second is time consuming and requires someone to be able to carefully rewrap the chocolate bar with silver foil that is hard to work with.

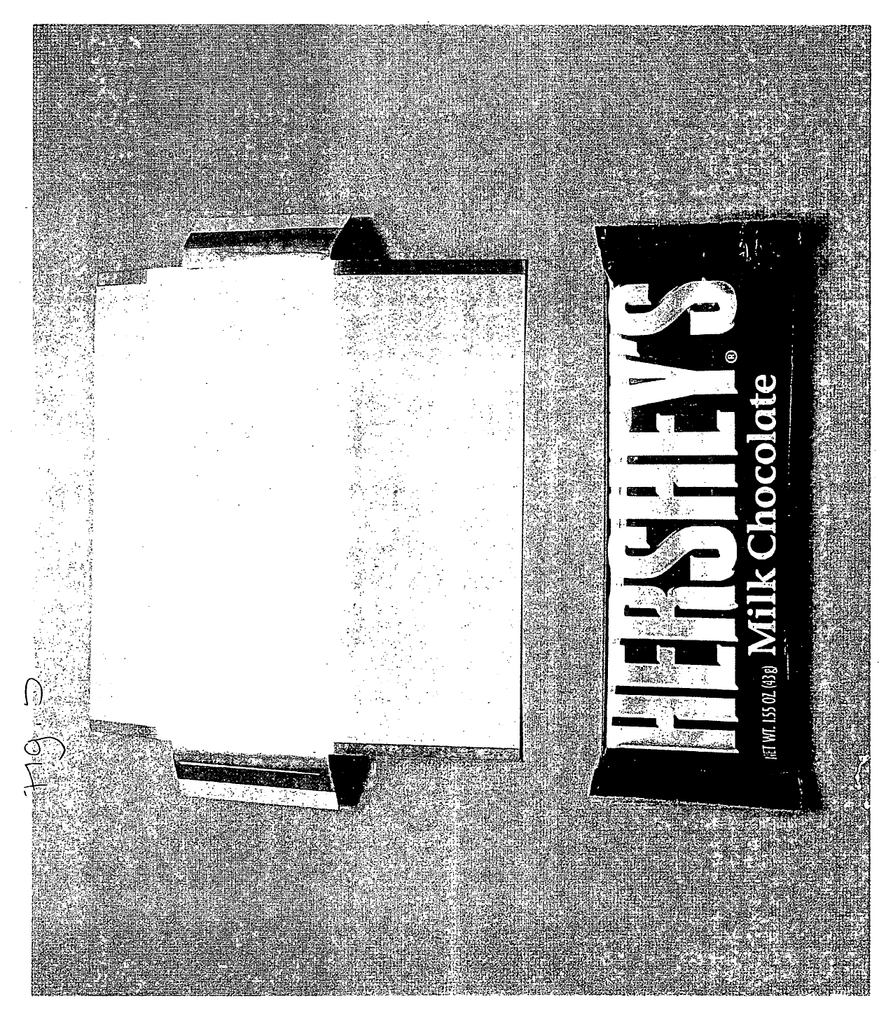

In one embodiment, the invention is a simulated silver foil technique that makes it easy to wrap the bar with a “greeted” label and have it have the look of a traditional silver wrapped chocolate bar. This can be done with a greeted wrapper that has silver material hot stamped or printed on the last ⅛″-¼″ of the right and left edges. This gives a quick visual appearance of silver foil but leaves the end unfinished. A superior solution esthetically is to create a wrapper with silver on both ends with tabs (also with silver foil appearance) that extend and fold around the edge (FIG. 5). This gives a more complete simulation of the silver foil since the end will also be covered. Any wrap technique that has hot stamped or printed silver that fools the eye into thinking it is a traditional silver foil wrapped candy bar will work.

Although these one-piece solutions may be the easiest to use, multi-piece solutions are also envisioned. Sleeves can be slipped over the right and left sides of the chocolate bar simulating the exposed silver ends. A silver foil bag could be used to simulate the silver foil. A shrink wrap wrapper could be used as long as the heat doesn't melt the chocolate bar and the shrink strength doesn't break the bar. A silver foil wrapper could be created with a trap door to slip in the bar or would be created out of an elastic silver foil.

The silver foil look can be created by hot stamping, glued on paper or foil layer, printing or any other technique to have it visually approximate the look of silver foil.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting. The invention is limited only as defined in the following claims and the equivalents thereto.

1. A candy bar wrapper, comprising:
a first portion constructed and arranged to, when folded, surround a candy bar;
wherein at least one edge of the first portion includes a strip of silver material.

2. The candy bar wrapper of claim 1, wherein two edges of the first portion include a strip of silver material.

3. The candy bar wrapper of claim 2, wherein the two edges are opposite each other.

4. The candy bar wrapper of claim 3, further comprising a tab attached to each edge.

5. The candy bar wrapper of claim 4, wherein the tab is silver.
